(19) United States
(12) Patent Application Publication
(10) Pub. No.: US 2005/0076621 A1
(43) Pub. Date: Apr. 14, 2005

(54) Air filter for an internal combustion engine

(76) Inventor: Yung-Yu Chang, Shan-Hua Chen (TW)

Correspondence Address: VENABLE, BAETJER, HOWARD AND CIVILETTI, LLP, P.O. BOX 34385, WASHINGTON, DC, 20043-9998, US

(21) Appl. No.: 10/681,258

(22) Filed: Oct. 9, 2003

(51) Int. Cl. B01D 50/00

(52) U.S. Cl. 55/320; 55/322; 55/337; 55/385.3

(57) ABSTRACT

An air filter includes a filter assembly and a base frame assembly. The filter assembly connects to the base frame assembly and filters particles from air prior to the air entering an internal combustion engine. The base frame assembly includes a base ring, a connecting bracket and an inner frame. The base ring has a ring configuration with a central through hole. The connecting bracket is mounted and held in the central through hole and has a clean air outlet, such as a through hole. The inner frame is mounted on the base ring over the through hole of the connecting bracket to spin clean air with powerful spinning currents to mix the clean air coming out of the clean air outlet with atomized fuel sprayed into the carburetor. Therefore, the well mixed air-fuel mixture will increase the gasoline engine performance.

### BACKGROUND OF THE INVENTION

1. Field of the Invention

The present invention relates to an air filter for an internal combustion engine, and more particularly to an air filter that will produce vortexes to speed clean air to mix thoroughly with atomized gasoline in a carburetor of a gasoline engine of the internal combustion engine.

2. Description of Related Art

An internal combustion engine, such as a gasoline engine burns a fuel and gas mixture such as gasoline and air to generate power. The intake air for the engine must be clean to ensure safe operation of the engine and prolong the engine life. Therefore, an air filter is commonly used to remove solids from the air to be introduced into an engine.

Since most gasoline engines are normally aspirated, air is sucked through an air filter and flows directly into cylinders. However, high-performance gasoline engines are supercharged, which means intake air entering the engine is first pressurized so that the air and fuel mixture is squeezed into the engine to increase performance. Therefore, a conventional air intake filter has a inner frame that has multiple vanes to spin the air coming into the filter simply without additional parts, such as a supercharger.

With reference to FIG. 6, an air filter in accordance with the prior art comprises a filter assembly (40) and a base frame (44). The filter assembly (40) is mounted on the base frame (44) that has a clean air outlet (441) connected to a carburetor (not shown) of a gasoline engine (not shown) for a vehicle (not shown). The filter assembly (40) comprises a top cap (41) and a filter element (45). The filter element (45) is mounted on the base frame (44), is tapered and has a top (not numbered), a bottom (not numbered), an inner space (not numbered), a narrow top opening (not numbered) and a broad bottom opening (not numbered). The narrow top opening and the broad bottom opening are aligned co-axially.

The top cap (41) is attached to the top of the filter element (45) and has an inner frame (not numbered) comprising an inward protrusion (42) and multiple vanes (43). The inward protrusion (42) extends into and is held in the inner space in the filter element (45) and has an outer periphery (not numbered). The vanes (43) are formed integrally on the outer periphery of the inward protrusion (42) to spin air that enters the inner space through the filter element (45) and generate spinning currents of air down inside the clean air outlet (441). The spinning currents speed the clean air entering the carburetor of the gasoline internal combustion engine so that the clean air will be mixed well with the atomized fuel spraying into the carburetor.

With reference to FIG. 7, another kind of the air filter in accordance with the prior art comprises a filter assembly (50) and a base frame (54). The base frame (54) is a modification of the previously described base frame and has a clean air outlet (541). The filter assembly (50) comprises a top annular cap (52) and a filter element (55) that has essentially the same features as the filter element previously described. The top cap (52) is mounted on the top of the filter element (55) and has an inner frame (not numbered) comprising an inward conical protrusion (51) and multiple vanes (53) formed integrally on the inward conical protrusion (51). The vanes (53) spin the air coming into the filter through the filter element (55) to produce the spinning currents of air down inside the clean air outlet (541) so that the clean air will be mixed well with the atomized fuel sprayed into the carburetor. However, the conventional air filters previously described have a common shortcoming. Specifically, the inward protrusions (42, 51) and air vanes (43, 53) are mounted in the top of the filter elements (45, 55) away from the clean air outlets (441, 541). A significant amount of the air passing through the filter elements (45, 55) and entering the clean air outlets (441, 541) is unaffected by the vanes (43, 53). Consequently, much of the clean air passing through the clean air outlets (441, 541) is not spinning enough to mix efficiently with the atomized fuel in the carburetor. Without sufficient of the air and the atomized fuel in the carburetor performance of the gasoline engine is less than optimum.

To overcome the shortcomings, the present invention provides an air filter for an internal combustion engine to mitigate or obviate the aforementioned problems.

### SUMMARY OF THE INVENTION

The main objective of the invention is to provide an air filter that has an inner frame to spin currents of clean air and is located across the path of incoming clean air that flows directly into the carburetor of a gasoline engine to maximize performance of a naturally aspirated gasoline engine.

An air filter in accordance with the present invention comprises a filter assembly and a base frame assembly. The filter assembly connects to the base frame assembly and filters particulates from air prior to the air entering an internal combustion engine, such as a gasoline engine of a vehicle. The base frame assembly is connected to a carburetor on the gasoline engine and comprises a base ring, a connecting bracket and an inner frame. The base ring has a ring configuration with an outer annular edge and a central through hole. The connecting bracket is mounted and held in the central through hole of the base ring and has a clean air outlet, such as a through hole. The inner frame is mounted on the base ring over the through hole of the connecting bracket to spin clean air entering the carburetor so the clean air will mix well with atomized fuel sprayed into the carburetor and maximize performance of the gasoline engine.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a first embodiment of an air filter in accordance with the present invention;

FIG. 2 is a cross sectional side plan view of the air filter in FIG. 1;

FIG. 3 is an exploded perspective view of a second embodiment of the air filter in accordance with the present invention;

FIG. 4 is a cross sectional side plan view of the air filter in FIG. 1;

FIG. 5 is an operational cross sectional side plan view of the air filter in FIG. 4 attached to a carburetor through a connecting tube;

FIG. 6 is a cross sectional side plan view of a first embodiment of a conventional air filter in accordance with the prior art; and

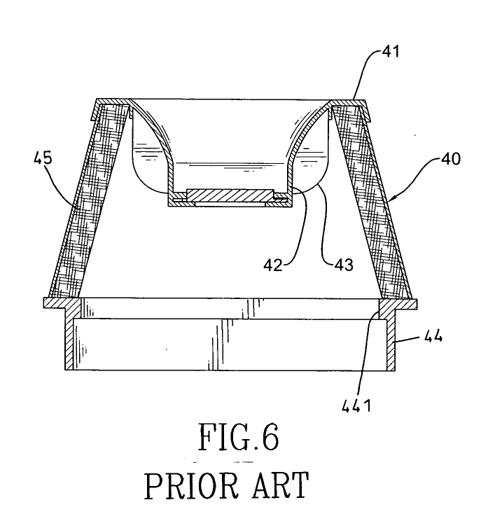

FIG. 7 is a cross sectional side plan view of a second embodiment of a conventional air filter in accordance with the prior art.

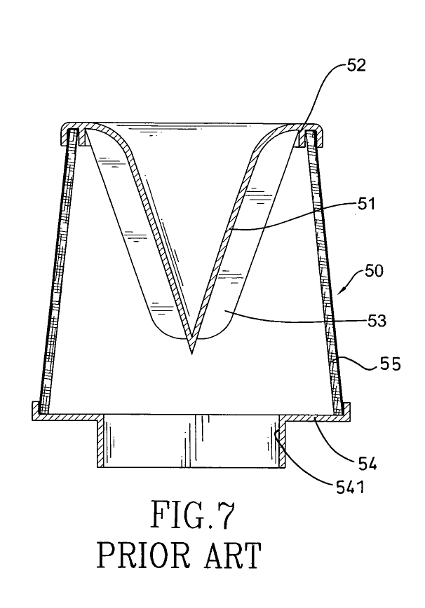

### DETAILED DESCRIPTION OF PREFERRED EMBODIMENT

An air filter in accordance with the present invention comprises a filter assembly and a base frame assembly. The filter assembly connects to the base frame assembly and filters particulates from air prior to the air entering an internal combustion engine, such as a gasoline engine. The base frame assembly is adapted to connect to a carburetor of the gasoline engine through a connecting tube and comprises a base ring, a connecting bracket and an inner frame. The base ring is a ring with an outer annular edge and a central through hole. The connecting bracket is mounted and held in the central through hole and has a clean air outlet, such as a through hole to hold the connecting tube. The inner frame is mounted on the base ring over the through hole in the connecting bracket to spin clean air.

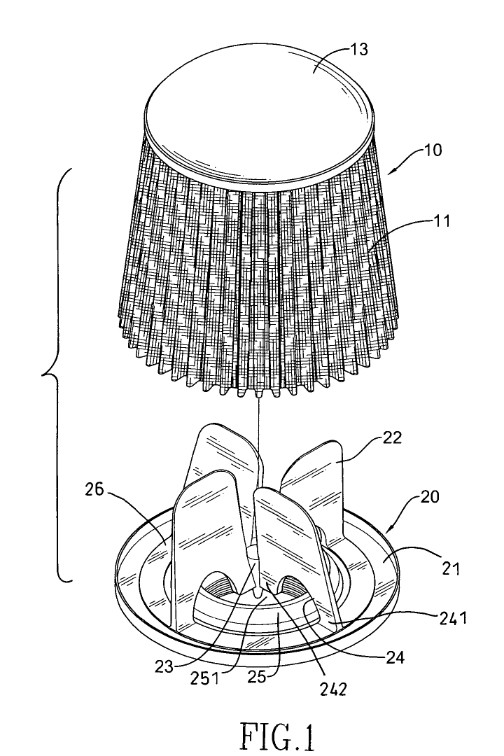

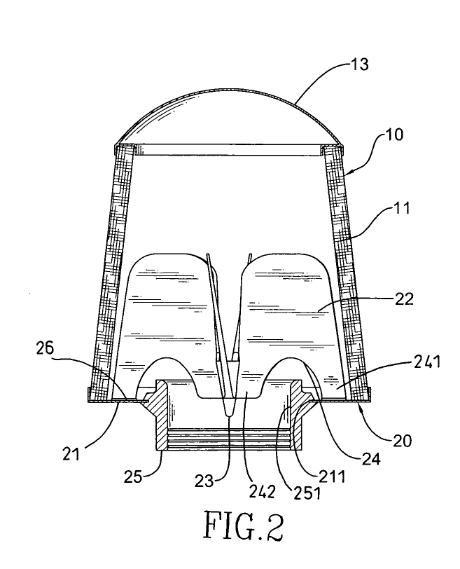

With reference to FIGS. 1 and 2, a first embodiment of an air filter in accordance with the present invention comprises a filter assembly (10) and a base frame assembly (20). The filter assembly (10) connects to the base frame assembly (20) and comprises a filter element (11) and a top end cap (13). The filter element (11) is fabricated in a conventional manner, is tapered and has an inner space (not numbered), a top (not numbered), a bottom (not numbered), a narrow top opening (not numbered), a broad bottom opening (not numbered) and a crenellated surface (not numbered). The narrow top opening is defined in the top and communicates with the inner space. Likewise, the broad bottom opening is defined in the bottom, communicates with the inner space and is co-axially aligned with the narrow top opening. The top end cap (13) is attached to the top of the filter element (11) to cover the narrow top opening.

The base frame assembly (20) connects to the filter element (11), extends partially into the inner space in the filter element (11) and simultaneously covers the broad bottom opening. The base frame assembly (20) comprises a base ring (21), a connecting bracket (25) and an inner frame (not numbered). The base ring (21) is attached to the bottom of the filter element (11) and has a top (not numbered), an annular lip (not numbered), an outer annular edge (not numbered) and a central through hole (211). The annular lip is formed at the outer annular edge and extends upward from the top to hold the filter element (11).

The connecting bracket (25) is mounted and held in the central through hole (211), is made of rubber and has a clean air outlet, such as a through hole (251) to allow clean air to enter the carburetor or manifold of the engine through a connecting tube (not shown). The inner frame is mounted on the top of the base ring (21) inside the inner space in the filter element (11) and comprises a central joining block (23), multiple vanes (22) and a connecting ring mount (26). Preferably, the inner frame has four vanes (22). Each vane (22) has a top (not numbered), a bottom (not numbered) and a bottom recess (24) defined in the bottom to form an outside leg (241) and an inside leg (242). The outside legs (241) of the vanes (22) connect integrally to the connecting ring mount (26) that is attached to the top of the base ring (21). The vanes (22) are arranged to produce vortexes of clean air as the clean air moves past the vanes (22). The inside legs (242) of the vanes (22) are attached to the central joining block (23) over the through hole (251) in the connecting bracket (25). The central joining block (23) can be a conical or a streamlined block.

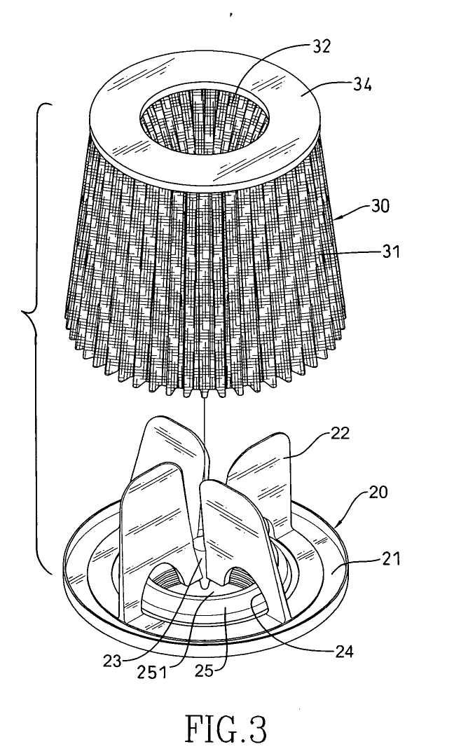

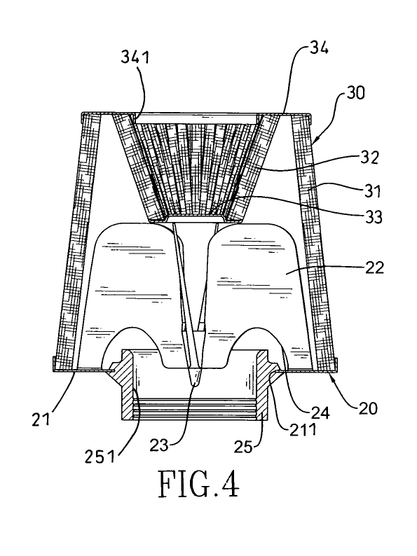

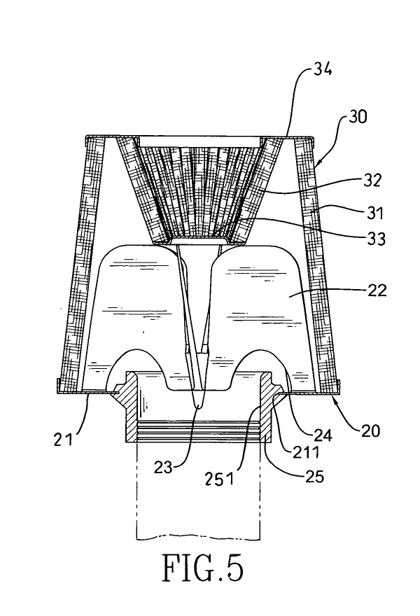

With reference to FIGS. 3, 4 and 5, a second embodiment of an air filter in accordance with the present invention is the same as the first embodiment except the filter assembly (10) of the first embodiment is modified. The modified filter assembly (30) comprises a primary filter element (31), a secondary filter element (32), a bottom end cover (33) and a top connecting ring (34). The filter elements (31, 32) are fabricated in a conventional manner. The primary filter element (31) is the same as the filter element (11) in the first embodiment. The top connecting ring (34) is mounted on the top of the primary filter element (31) and has an outer annular lip (not numbered), a through hole (341) and a bottom (not numbered). The outer annular lip of the top connecting ring (34) extends downward and holds the top of the primary filter element (31) to connect the top connecting ring (34) to the primary filter element (31).

The secondary filter element (32) is attached to the bottom around the through hole (341) in the top connecting ring (34) and is tapered downward. The secondary filter element (32) extends inward, is held in the inner space in the primary filter element (31) and has a bottom (not numbered) and a narrow bottom opening (not numbered) defined in the bottom. The inside bottom end cover (33) is attached to the bottom of the secondary filter element (12) to cover the bottom narrow opening to enclosure the inner space and abut the tops of the vanes (22).

Consequently, as in all aforesaid embodiments, the air outside the air filter will be sucked into the inner space in the filter elements (11, 31) by the operating engine and through the through hole (251) in the connecting bracket (25). The filter elements (11, 31, 32) filter particles from the air to clean the air. The clean air will move over the vanes (22) prior to moving out of the air filter through the through hole (251) in the connecting bracket (25). When the clean air moves over through the vanes (22), the bottom recesses (24) of the vanes (22) allow the clean air to pass through. The movement of the clean air over the vanes (22) and through the bottom recesses (24) will produce vortexes inside the through hole (251) of the connecting bracket (25). Since the spinning currents of clean air will directly flow into the through hole (251), the vortexes in the clean air will cause the clean air to mix efficiently with atomized fuel sprayed into carburetor. Consequently, the fuel-air mixture is homogenous in all cylinders, and the engine performs more efficiently.

Even though numerous characteristics and advantages of the present invention have been set forth in the foregoing description, together with details of the structure and functions of the invention, the disclosure is illustrative only, and changes may be made in detail, especially in matters of shape, size, and arrangement of parts within the scope of the appended claims.

1. An air filter for an internal combustion engine and the air filter comprising:
a filter assembly for filtering particles from air prior to the air entering into the internal combustion engine; and
a base frame assembly connecting to the filter assembly and comprising
a base ring connecting to the filter assembly and having a top and a ring configuration with an outer annular edge and a central through hole;
a connecting bracket mounted and held in the central through hole in the base ring and having a clean air outlet; and
an inner frame mounted on the base ring to spin the air and having multiple vanes mounted on and extending upward from the top of the base ring and arranged to cause the air to spin, and each of the vanes having a top, a bottom and a bottom recess defined in the bottom;
whereby when the air passes over the inner frame, the vanes spin the air with spinning currents moving through the bottom recesses and down into the clean air outlet of the connecting bracket.

2. The air filter as claimed in claim 1, wherein
the inner frame further comprises a connecting ring mount mounted on the top of the base ring and a central joining block to connect the vanes; and
each of the vanes further has an outside leg and an inside leg formed beside the bottom recess, the outside legs of the vanes connect integrally to the connecting ring mount, and the inside legs of the vanes are attached to the central joining block together over the clean air outlet of the connecting bracket.

3. The air filter as claimed in claim 1, wherein the filter assembly comprises:
a filter element being tapered and having an inner space, a top, a bottom, a top opening defined in the top communicating with the inner space and a bottom opening defined in the bottom communicating with the inner space and co-axially aligned with the top opening, and the bottom of the filter element mounted on the top of the base ring; and
a top end cap attached to the top of filter element to cover the top opening;
wherein the inner frame is mounted and held in the inner space of the filter element.

4. The air filter as claimed in claim 2, wherein the filter assembly comprises:
a filter element being tapered and having an inner space, a top, a bottom, a top opening defined in the top and communicating with the inner space and a bottom opening defined in the bottom, communicating with the inner space and co-axially aligned with the top opening, and the bottom of the filter element mounted on the top of the base ring; and
a top end cap attached to the top of the filter element to cover the top opening;
wherein the inner frame is mounted and held in the inner space of the filter element.

5. The air filter as claimed in claim 1, wherein the filter assembly comprises:
a primary filter element being tapered and having an inner space, a top, a bottom, a top opening defined in the top and communicating with the inner space and a bottom opening defined in the bottom, communicating with the inner space and co-axially aligned with the top opening, and the bottom of the filter element mounted on the top of the base ring;
a top connecting ring mounted on the top of the primary filter element and having an outer annular lip extending downward and holding the top of the primary filter element, a through hole and a bottom;
a secondary filter element attached to the bottom around the through hole of the top connecting ring, being tapered and having a bottom and a bottom opening defined in the bottom; and
an inside bottom end cover attached to the bottom of the secondary filter element to cover the bottom opening of the secondary filter element to enclosure the inner space;
wherein the inner frame is mounted and held in the inner space of the primary filter element.

6. The air filter as claimed in claim 2, wherein the filter assembly comprises:
a primary filter element being tapered and having an inner space, a top, a bottom, a top opening defined in the top and communicating with the inner space and a bottom opening defined in the bottom, communicating with the inner space and co-axially aligned with the top opening, and the bottom of the filter element mounted on the top of the base ring;
a top connecting ring mounted on the top of the primary filter element and having an outer annular lip extending downward and holding the top of the primary filter element, a through hole and a bottom;
a secondary filter element attached to the bottom around the through hole in the top connecting ring, being tapered and having a bottom and a bottom opening defined in the bottom; and
an inside bottom end cover attached to the bottom of the secondary filter element to cover the bottom opening of the secondary filter element to enclosure the inner space;
wherein the inner frame is mounted and held in the inner space of the primary filter element.

7. The air filter as claimed in claim 6, wherein the central joining block is a conical block.
